(19) United States
(12) Patent Application Publication
(10) Pub. No.: US 2025/0081935 A1
(43) Pub. Date: Mar. 13, 2025

(54) METHODS AND APPARATUS FOR A CUSTOMIZABLE ID TAG SYSTEM

(71) Applicant: FESLER HOLDINGS, LLC, Scottsdale, AZ (US)

(72) Inventors: Carrie Fesler, Phoenix, AZ (US); Christopher Fesler, Phoenix, AZ (US); Jason Nelson, Phoenix, AZ (US)

(73) Assignee: FESLER HOLDINGS, LLC, Scottsdale, AZ (US)

(21) Appl. No.: 18/464,937

(22) Filed: Sep. 11, 2023

(51) Int. Cl. A01K 27/00; A01K 11/00; G09F 3/02; G09F 3/14

(52) U.S. Cl. CPC A01K 11/00; G09F 3/0288; G09F 3/14

(57) ABSTRACT

A customizable ID tag system according to various aspects of the present technology may comprise a detachable case comprising a slot; at least one connection point connected to the case; at least one interchangeable tile configured to display information; and an attachment interface configured to releasably couple the interchangeable tile to the case slot of the case. The connection point allows the ID tag system to be removably attached to a leash or collar. The interchangeable tile may be configured to display one or more types of information such as letters, numbers, designs, emojis, or messages.

### BACKGROUND OF THE TECHNOLOGY

ID tags for pet collars are a common way for pet owners to provide contact information in the event that their pet runs away or gets lost. These tags can provide various types of information including names, addresses, phone numbers, tracking chip numbers, and in some instances medical information. A common method of creating an ID tag is to engrave or emboss a metal or plastic tag that can be attached to a collar or leash. A drawback of these types of ID tags is that they are fixed and cannot be modified. In addition, they tend to be very standardized and allow for very little customization or uniqueness. Further, if any of the information changes, the ID tag cannot be updated with new information and must be replaced. A customizable ID tag system would allow a user to customize the look, feel, and function of the collar by changing the information displayed on the ID tag.

### SUMMARY OF THE TECHNOLOGY

A customizable ID tag system according to various aspects of the present technology may comprise a detachable case comprising a slot; at least one connection point connected to the case; at least one interchangeable tile configured to display information; and an attachment interface configured to releasably couple the interchangeable tile to the case slot of the case. The connection point allows the ID tag system to be removably attached to a leash or collar. The interchangeable tile may be configured to display one or more types of information such as letters, numbers, designs, emojis, or messages.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a customizable ID tag system in accordance with an exemplary embodiment of the present technology;

FIG. 2 representatively illustrates a rear facing portion of the customizable ID tag system in accordance with an exemplary embodiment of the present technology;

FIG. 3 representatively illustrates a forward facing portion of a customizable ID tag system in accordance with an exemplary embodiment of the present technology;

FIG. 4 representatively illustrates an interchangeable tile in accordance with an exemplary embodiment of the present technology;

FIG. 5 representatively illustrates a view of a front portion of a customizable ID tag system with an interchangeable tile partially inserted in accordance with an exemplary embodiment of the present technology; and

FIG. 6 representatively illustrates a customizable ID tag system connected to a collar in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials and connection devices for manufacturing the customizable ID tag system for a collar. In addition, the present technology may be practiced in conjunction with various types of collars, bracelets, identification tags, or other linking systems, and the system described is merely one exemplary application for the technology. Methods and apparatus for a customizable ID tag system for a collar according to various aspects of the present technology may operate in conjunction with any suitable materials such as plastic, silicone, metal, or other natural or synthetic materials.

The customizable ID tag system comprises a case and interchangeable tiles that can be easily swapped and replaced allowing the user to customize the ID tag system with one or more desired interchangeable tiles. The case is designed to securely hold the interchangeable tiles in place, while also allowing for the interchangeable tiles to be removed without the use of tools. The interchangeable tiles are designed to fit within the case to display various information such as the pet's name, age, owner's contact details, medical conditions, emojis, designs, QR codes, or various other types of messages. The user can also choose from different fonts, icons, and backgrounds for the tiles, or even upload their own images or designs to a system to be transferred onto an interchangeable tile. For example, in one embodiment, the user may be able to select one or two interchangeable tiles with a number on it to display the age of their pet when inserted into the case. In another embodiment, the user might select a tile with a design suggesting that their pet is a male or another tile suggesting that their pet is female.

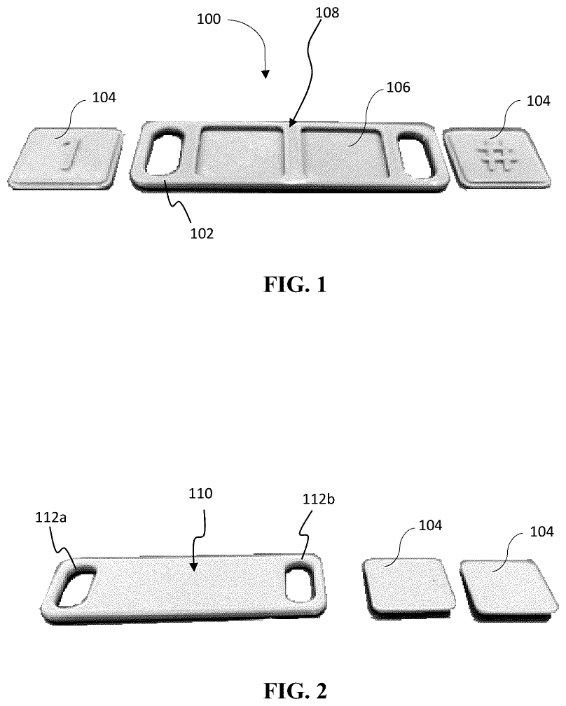

Referring to FIGS. 1-6, a customizable ID tag system 100 may comprise a case 102 comprising a receiving slot 106 and at least one interchangeable tile 104. The case 102 may be configured in any suitable shape or size, such as rectangles, squares, ovals, hearts, and circles, and may comprise any suitable materials, such as plastic, metal, ceramic, glass, precious metals, and the like. The customizable ID tag system may be made using any suitable method, such as injection molding, molded plastic, 3D printed, stamped metal, or any other suitable fabrication technique for a given type of material.

The case 102 may be configured in any suitable manner to define a receiving slot 106. The receiving slot 106 may be adapted for storage and display of any material and/or an object attached, adhered, embedded, or otherwise coupled to the receiving slot 106 to provide a changeable display of the material and/or object, such as the interchangeable tile 104. For example, the receiving slot 106 may be configured to receive or otherwise hold the interchangeable tile 104 in a secured and fixed position.

The receiving slot 106 may be located on any surface of the case 102, such as the front, the back, or the sides. In one embodiment, referring to FIGS. 1-3, in one embodiment, the case 102 may comprise a front portion 108, a back portion 110 and a first and second connection point 112a, 112b, wherein the receiving slot 106 is disposed in the front portion 108 of the case 102. The receiving slot 106 may comprise any dimensions adapted to store and display the interchangeable tile 104.

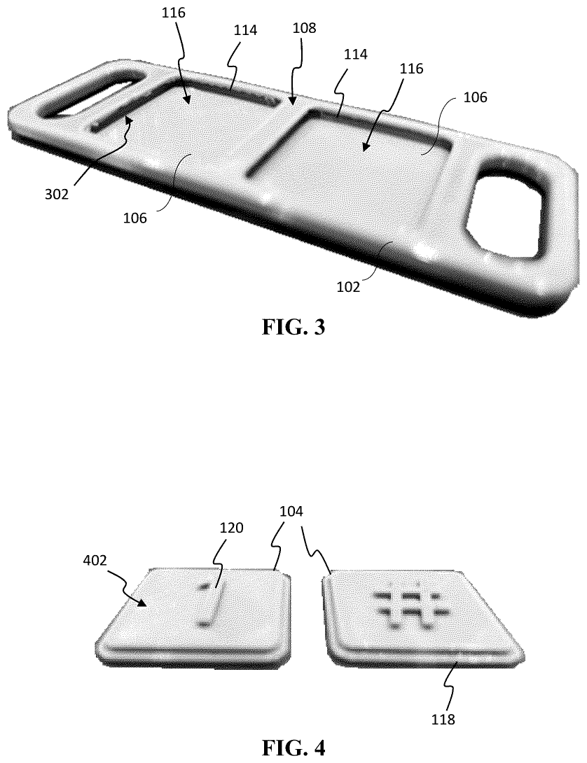

In one embodiment, and referring now to FIGS. 3-5, the receiving slot 106 may comprise a recessed interior cavity 116 disposed in the front portion 108 of the case 102 and defined by a peripheral edge portion 114. The recessed interior cavity 116 may be configured to receive the interchangeable tile 104. The peripheral edge portion 114 and recessed interior cavity 116 may comprise any suitable dimensions configured to receive the interchangeable tile 104. For example, the recessed interior cavity 116 may have a depth that allows a main upper surface 402 of the interchangeable tile 104 to be flush with the front portion 108 of the case 102 when the interchangeable tile 104 is inserted and fixed into place.

The peripheral edge portion 114 releasably holds the interchangeable tile 104 in place and may be configured in any suitable manner to securely hold the interchangeable tile 104. For example, the peripheral edge portion 114 may comprise a rearward-facing perimeter surface forming a shaped outer edge that may at least partially define the interior surface of the recessed interior cavity 116. In some embodiments, the rearward-facing perimeter surface of the peripheral edge portion 114 may comprise a flange 302 or lip that slightly overhangs an upward facing surface of the recessed interior cavity 116.

The receiving slot 106 may also comprise a mechanism that facilitates the insertion and removal of interchangeable tile 104, such as a spring-loaded latch, a sliding rail, a hinge or a button. In one embodiment, the back portion 110 of the case 102 may comprise a semi-rigid flexible material to allow user to push against the back surface of the back portion 110 of the case 102 to displace the interchangeable tile 104 from the receiving slot 106. In another embodiment, the upward facing surface of the recessed interior cavity 116 may be configured to magnetically secure the interchangeable tile 104 in position.

In some embodiments, the case 102 may comprise a plurality of slots 106. For example, referring again to FIGS. 1 and 2, in one embodiment the case 102 may be configured in a single piece with two or more slots 106 to allow for additional customization. In an alternative embodiment, the customizable ID tag system 100 may comprise multiple cases 102 configured to attach to one another via any suitable mechanism (not shown). A plurality of cases 102 may be disposed adjacent with respect to each other in a continuous row along a leash or collar. The adjacent cases 102 may be detachably joined together by an engagement mechanism. For example, in one embodiment, the engagement mechanism may comprise the first and second connection points 112a, 112b may be located on opposite end portions of the case 102 and configured to connect via snap-fit, magnetic, or other suitable mechanism to secure two or more cases 102 together.

The interchangeable tile 104 displays a selectable desired message or information when connected to the case 102. The interchangeable tile 104 is adapted for insertion into the receiving slot 106 of the case 102 and may have appropriate dimensions to be inserted into the receiving slot 106 and fit relatively snugly to maintain position in the receiving slot 106. For example, the interchangeable tile 104 may have a shape and size that corresponds to the shape and size of the receiving slot 106 of the case 102. The interchangeable tile 104 may be configured to be secured to the receiving slot 106 by any suitable method such as a pressure fit within the receiving slot 106 of the case 102, snapped into place, magnetically, or a tongue-and-groove system.

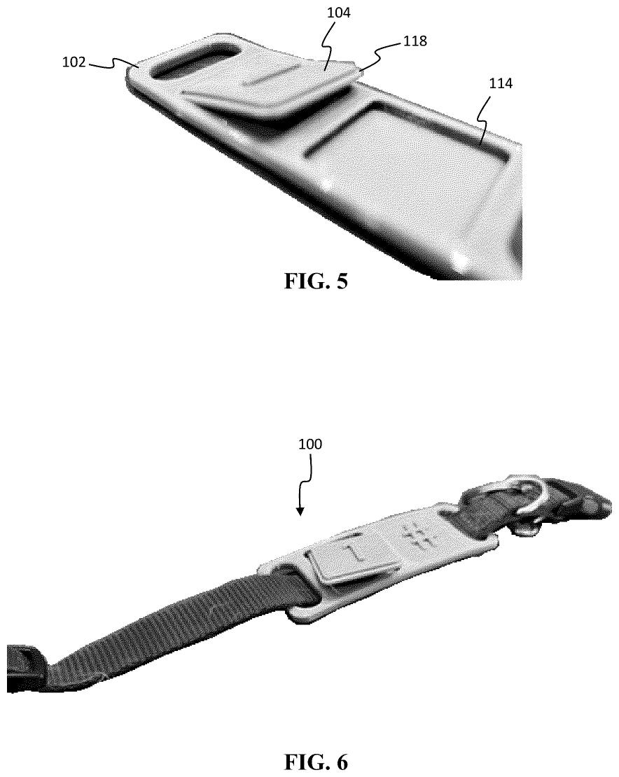

In one embodiment, referring to FIGS. 4-5, the interchangeable tile 104 may comprise an outside edge 118 slightly smaller than an outer most edge portion of the receiving slot 106. The outside edge 118 may define a surface having a groove or notch configured to frictionally engage the interior surface of the peripheral edge portion 114 of the receiving slot 106.

With reference now to FIG. 4, an outwardly facing front surface of the interchangeable tile may comprise a decorative surface 120. For example, the decorative surface 120 of the interchangeable tile 104 may be used to display various information. The interchangeable tile 104 can be easily swapped with another tile without having to replace the entire collar or ID tag if the information changes or if the user wants to display different information for different occasions. For example, the decorative surface 120 of the interchangeable tile 104 may be engraved or etched with alphanumeric characters, images, text, graphics, logos, icons, symbols, or any suitable combination to convey desired information. For example, the decorative surface 120 of each of the interchangeable tiles 104 may display different pieces of information about a pet and its owner, such as a pet's name, its age, owner's contact details, medical conditions, or QR codes.

The interchangeable tiles 104 may comprise any suitable such as color, shape, material or design, such as such as identification information, decorative patterns, or functional elements. Some interchangeable tiles 104 may also include additional features, such as a GPS tracker, LED lights, name tags, or charms. In various embodiments, the user can also choose from different fonts, icons, and backgrounds for the tiles, or even upload their own images or designs.

The case 102 may comprise one or more connection points to facilitate attachment to a collar. The connection points may comprise any appropriate system for coupling the case 102 to a collar, such as one or more loops, clamps, magnetic couplings and/or closures, threaded surfaces, hinges, springs, locks, connectors, clips, friction fittings, rivets, adhesives, pins, clamps, ties or any suitable combination. Referring to FIGS. 1 and 6, in one embodiment, the case 102 comprises a first and second connection point 112a, 112b located on opposite ends of the case 102 configured to attach the case 102 to a collar using various methods. For example, in one embodiment, the first and second connection point 112a, 112b may comprise loops at opposite ends of the case 102 through which a user may thread the collar. In an alternative embodiment, the first and second connection points 112a, 112b may comprise a mechanical fastening device such as a quick release buckle.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Although embodiments of the present technology have been described with reference to a customizable ID tag system for a collar, the technology should not be viewed as being limited in that respect. As would be familiar with one of ordinary skill in the art after becoming familiar with the teachings of the present technology, the subject matter could also be used with other types of bracelets, belts, suitcase tags and the like.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A customizable ID tag system for a collar, comprising:
a case, comprising:
a front portion, comprising receiving slot forming a recessed interior cavity and defined by a peripheral edge portion, wherein:
the recessed interior cavity comprises an interior surface; and
the peripheral edge portion comprises a rearward-facing perimeter surface defining a shaped outer edge over the interior surface of the recessed interior cavity;
a back portion comprising a rear-facing surface;
a first connection point disposed along a first side of at least one of the back portion and the front portion; and
a second connection point disposed along a second side of at least one of the back portion and the front portion opposite the first connection point; and
at least one interchangeable tile, comprising:
a body;
a front surface; and
a forward-facing perimeter surface adapted to releasably engage the shaped outer edge of the rearward-facing perimeter surface of the peripheral edge portion.

2. The customizable ID tag system for a collar of claim 1, wherein the front portion further comprises a second receiving slot forming a second recessed interior cavity and defined by a second peripheral edge portion, wherein:
the second recessed interior cavity comprises a second interior surface; and
the second peripheral edge portion comprises a second rearward-facing perimeter surface forming a second shaped outer edge over the second interior surface of the second recessed interior cavity.

3. The customizable ID tag system for a collar of claim 1, wherein:
the shaped outer edge of the peripheral edge portion of the front portion comprises an outer perimeter flange extending along the shaped outer edge; and
the forward-facing perimeter surface of the at least one interchangeable tile comprises a notched outer edge configured to frictionally engage the outer perimeter flange.

4. The customizable ID tag system for a collar of claim 1, wherein the first and second connection points are disposed along opposing ends of the case.

5. The customizable ID tag system for a collar of claim 1, wherein the first and second connection point each comprise a loop structure.

6. The customizable ID tag system for a collar of claim 1, wherein the rear-facing surface of the back portion is comprised of a semi-rigid flexible material.

7. The customizable ID tag system for a collar of claim 1, wherein the front surface of the interchangeable tile comprises a decorative surface.

8. The customizable ID tag system for a collar of claim 1, wherein the front surface of the interchangeable tile comprises at least one of LED lights, name tags, and charms.

9. A collar tag system connectable to a collar, comprising:
a case, comprising:
a front body portion, comprising:
a receiving slot comprising a recessed interior cavity; and
a rearward-facing perimeter surface disposed above a surface of the recessed interior cavity;
a back body portion comprising a rear-facing surface;
a first connection attached to a first portion of the case; and
a second connection point attached to a second portion of the case and
at least one interchangeable tile, comprising:
a body;
a front surface; and
a forward-facing perimeter surface disposed outwardly from the front surface and adapted to be removably received within the recessed interior cavity of the front portion and configured to frictionally engage the rearward-facing perimeter surface of the front body portion.

10. The collar tag system for a collar of claim 9, wherein the front body portion further comprises:
a second receiving slot comprising second interior recessed cavity; and
a second rearward-facing perimeter surface disposed above a surface of the second recessed interior cavity.

11. The collar tag system for a collar of claim 9, wherein:
the rearward-facing perimeter surface of the front body portion comprises an outer perimeter flange; and
the forward-facing perimeter surface of the at least one interchangeable tile comprises a notched outer edge configured to frictionally engage the outer perimeter flange.

12. The collar tag system for a collar of claim 9, wherein the first and second connection point comprises at least one of loops, clamps, magnetic couplings and/or closures, threaded surfaces, hinges, springs, locks, connectors, clips, friction fittings, rivets, adhesives, pins, clamps, and ties.

13. The collar tag system for a collar of claim 9, wherein the rear-facing surface of the back portion is comprised of a semi-rigid flexible material.

14. The collar tag system for a collar of claim 9, wherein the front body portion further comprise at least one of a spring-loaded latch, a sliding rail, a hinge or a button.

15. The collar tag system for a collar of claim 9, wherein the front surface of the interchangeable tile comprises a decorative surface.

16. The collar tag system for a collar of claim 9, wherein the front surface of the interchangeable tile comprises at least one of LED lights, name tags, and charms.
